(19) United States
(12) Patent Application Publication
(10) Pub. No.: US 2018/0164624 A1
(43) Pub. Date: Jun. 14, 2018

(54) SPLICING-TYPE LIQUID CRYSTAL DISPLAY DEVICE

(71) Applicant: Wuhan China Star Optoelectronics Technology Co., Ltd., Wuhan, Hubei (CN)

(72) Inventor: Chang XIE, Shenzhen, Guangdong (CN)

(73) Assignee: Wuhan China Star Optoelectronics Technology Co., Ltd., Wuhan, Hubei (CN)

(21) Appl. No.: 15/112,494

(22) PCT Filed: Jun. 29, 2016
(86) PCT No.: PCT/CN2016/087673

§ 371 Date: Jul. 19, 2016

(30) Foreign Application Priority Data
Jun. 20, 2016 (CN) 201610444767.2

(51) Int. Cl. G02F 1/1333; G02F 1/133; H02S 40/38; H02S 40/36; H02S 99/00; G09F 9/35

(52) U.S. Cl. CPC G02F 1/13336; G02F 1/13306; H02S 40/38; G02F 1/1368; H02S 99/00; G09F 9/35; H02S 40/36

(57) ABSTRACT

The invention provides a splicing-type liquid crystal display device including multiple liquid crystal display screens arranged in an array. The liquid crystal display screens have a splicing gap formed thereamong. A solar cell is disposed in the splicing gap, and the solar cell is electrically connected with the liquid crystal display screens. Therefore, the splicing-type liquid crystal display device of the invention can improve endurance of the splicing-type display screen.

### CROSS REFERENCE TO RELATED APPLICATION

This application claims the priority of Chinese Patent Application No. 201610444767.2, entitled “Splicing-type Liquid Crystal Display Device”, filed on Jun. 20, 2016, the disclosure of which is incorporated herein by reference in its entirety.

### FIELD OF THE INVENTION

The invention relates to the field of liquid crystal manufacturing technology, and particularly to a splicing-type liquid crystal display device.

### BACKGROUND OF THE INVENTION

A liquid crystal panel is a main component of a liquid crystal display screen, and it requires a certain energy consumption for driving the liquid crystal panel to display. In the prior art, when the light passes through polarizers of the liquid crystal panel, transmittance of the light is about 43%, that is, more than one half of the light energy is blocked. Moreover, when the light passes through a color filter of the liquid crystal panel, a black matrix (BM) thereof is completely opaque. If the light emitted from a backlight source is 100%, after passing through various layer structures of the liquid crystal panel, an overall transmittance of the light only is about 3%-6%. Since the overall light transmittance of the liquid crystal display screen is low, in order to maintain a normal high brightness display of the liquid crystal display screen, a relatively high voltage is needed to be applied, which would cause power consumption of the liquid crystal display screen to be excessively large, so that the endurance of battery of the liquid crystal display screen is sharply reduced.

Due to limited area of a single liquid crystal display screen, in order to meet large-area display requirements of exhibitions, advertisings and so on, multiple (i.e., more than one) liquid crystal display screens usually are spliced into a large-scale splicing-type display screen so as to achieve the large-area display. However, the splicing-type display screen spliced by multiple liquid crystal display screens would have higher power consumption, so that the endurance defect of the splicing-type display screen is more serious.

### SUMMARY OF THE INVENTION

Accordingly, the invention provides a splicing-type liquid crystal display device capable of improving endurance of the splicing-type display screen.

Specifically, a splicing-type liquid crystal display device includes multiple liquid crystal display screens arranged in an array. The liquid crystal display screens have a splicing gap formed thereamong. A solar cell is disposed in the splicing gap, and the solar cell is electrically connected with the liquid crystal display screens.

In an embodiment, the liquid crystal display screens each include a display screen battery, and the solar cell is electrically connected with the display screen battery.

In an embodiment, the solar cell is electrically connected with backlight sources of the liquid crystal display screens.

In an embodiment, the solar cell is electrically connected with data driving circuits of the liquid crystal display screens.

In an embodiment, the splicing gap is disposed with multiple solar cells, and each of the solar cells is electrically connected with a corresponding one of the liquid crystal display screens.

In an embodiment, the solar cell is a photoelectric conversion film.

In an embodiment, the liquid crystal display screens each include a protective border, and the protective borders of the liquid crystal display screens together define the splicing gap.

In an embodiment, the liquid crystal display screens each is a thin film transistor liquid crystal display screen.

Sum up, the splicing-type liquid crystal display device of the invention disposes the solar cell(s) in the splicing gap, and the solar cell(s) is/are electrically connected with the liquid crystal display screens for supplying power. In outdoor environment, it can effectively make use of solar energy to satisfy the power consumption of the splicing-type display screen, so that the consumption of the splicing-type display screen on traditional energy is reduced ad the endurance of the splicing-type display screen is improved.

### BRIEF DESCRIPTION OF THE DRAWINGS

In order to more clearly illustrate technical solutions of embodiments of the invention, drawings will be used in the description of embodiments will be given a brief description below. Apparently, the drawings in the following description only are some of embodiments of the invention, the ordinary skill in the art can obtain other drawings according to these illustrated drawings without creative effort.

FIG. 1 is a schematic structural view of multiple liquid crystal display screens being spliced together in a splicing-type liquid crystal display device according to an embodiment of the invention.

FIG. 2 is a schematic view of a distribution of a solar cell in the splicing-type liquid crystal display device according to the embodiment of the invention.

### DETAILED DESCRIPTION OF THE PREFERRED EMBODIMENTS

In the following, with reference to accompanying drawings of embodiments of the invention, technical solutions in the embodiments of the invention will be clearly and completely described. Apparently, the embodiments of the invention described below only are a part of embodiments of the invention, but not all embodiments. Based on the described embodiments of the invention, all other embodiments obtained by ordinary skill in the art without creative effort belong to the scope of protection of the invention.

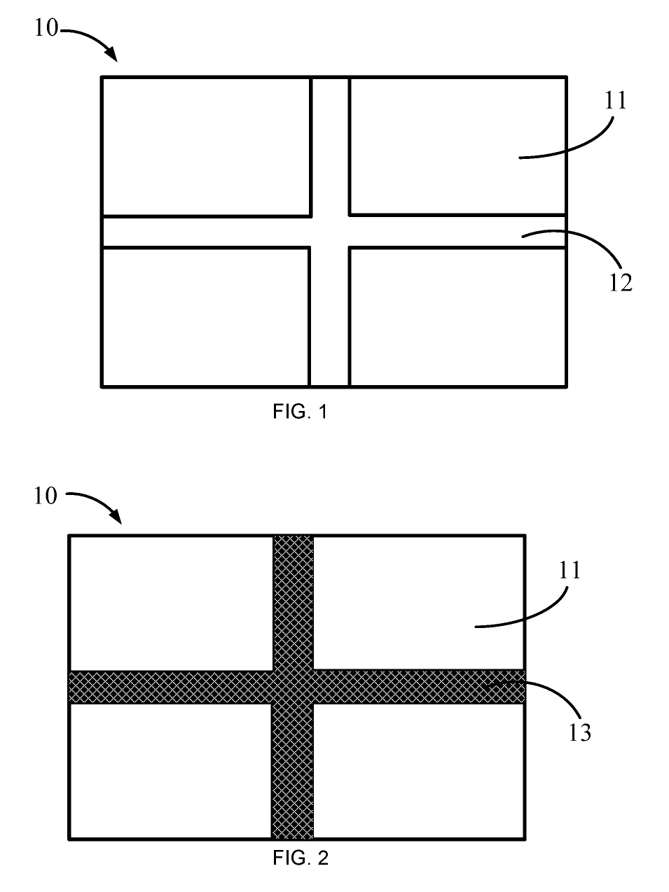

Referring to FIG. 1, a splicing-type liquid crystal display device 10 according to an embodiment of the invention includes multiple (i.e., more than one) liquid crystal display screens 11 arranged in an array. The multiple liquid crystal display screens 11 have a splicing gap 12 formed thereamong. The splicing gap 12 is formed by protective borders of the liquid crystal display screens 11. FIG. 1 illustrates 2*2, i.e., 4 in total, numbers of liquid crystal display screens 11 as an example for description, but it should be understood that the invention is not limited to this.

In the illustrated embodiment, the liquid crystal display screens 11 each are a thin film transistor liquid crystal display screen. The thin film transistor liquid crystal display screen is the mainstream product in liquid crystal display screens. The thin film transistor liquid crystal display screen is a multi-layered structure and includes a display screen battery, a backlight source and a data driving circuit, etc., in its interior. An overall light transmittance of the thin film transistor liquid crystal display screen is relatively low, in order to maintain a normal high brightness display, a relatively high voltage is required to be applied, which causes the power consumption of the liquid crystal display screen to be excessively large, so that the endurance of the display screen battery is sharply reduced. In other embodiment, the liquid crystal display screens 11 each may be other type liquid crystal display screen.

Referring to FIG. 2, the splicing gap 12 is disposed with a solar cell 13 therein. Since the splicing gap 12 is disposed with the solar cell 13, it can effectively make use of non-display areas of the liquid crystal display screens 11 and thus does not affect normal displays. Moreover, because the splicing gap 12 is located at a position of directly receiving light, the solar cell 13 is disposed here and thus can more effectively absorb light energy.

The solar cell 13 is a photoelectric conversion film and can convert the absorbed light energy into electric energy. In the illustrated embodiment, the solar cell 13 is a single piece of photoelectric conversion film and electrically connected with each of the liquid crystal display screens 11 so as to deliver electric energy obtained after photoelectric conversion to each of the liquid crystal display screens 11. In other embodiment, the splicing gap 12 can be disposed with multiple solar cells 13 instead, and each of the solar cells 13 is electrically connected with the liquid crystal display screen 11 neighboring therewith so as to deliver electric energy; and/or the solar cell may be other type device which can perform photoelectric conversion to output electric energy.

In addition, in the illustrated embodiment, the solar cell 13 is electrically connected with a backlight source of each of the liquid crystal display screens 11 and thus the solar cell 13 directly powers the backlight source; or, the solar cell 13 is electrically connected with a data driving circuit of each of the liquid crystal display screens 11 ad thus the solar cell 13 directly powers the data driving circuit; or the solar cell 13 is electrically connected with a display screen battery of each of the liquid crystal display screens 11 and thus the solar cell directly supplies electric energy to the display screen battery. In other embodiment, the solar cell 13 may be electrically connected with other circuit assembly of each of the liquid crystal display screens 11.

Accordingly, the splicing-type liquid crystal display device according to the embodiments of the invention, by disposing the solar cell(s) in the splicing gap and the solar cell(s) being electrically connected with the liquid crystal display screen(s) for supplying power, so that in outdoor environment, it can effectively make use of solar energy to satisfy the power consumption of the splicing-type display screen, reduce the consumption of the splicing-type display screen on traditional energy and increase the endurance of the splicing-type display screen.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A splicing-type liquid crystal display device comprising a plurality of liquid crystal display screens arranged in an array; wherein the plurality of liquid crystal display screens have a splicing gap formed thereamong, a solar cell is disposed in the splicing gap, and the solar cell is electrically connected with the plurality of liquid crystal display screens.

2. The splicing-type liquid crystal display device as claimed in claim 1, wherein the plurality of liquid crystal display screens each comprise a display screen battery, and the solar cell is electrically connected with the display screen battery.

3. The splicing-type liquid crystal display device as claimed in claim 1, wherein the solar cell is electrically connected with backlight sources of the plurality of liquid crystal display screens.

4. The splicing-type liquid crystal display device as claimed in claim 1, wherein the solar cell is electrically connected with data driving circuits of the plurality of liquid crystal display screens.

5. The splicing-type liquid crystal display device as claimed in claim 1, wherein the splicing gap is disposed with a plurality of the solar cell, and each of the plurality of solar cells is electrically connected with a corresponding one of the plurality of liquid crystal display screens.

6. The splicing-type liquid crystal display device as claimed in claim 1, wherein the solar cell is a photoelectric conversion film.

7. The splicing-type liquid crystal display device as claimed in claim 2, wherein the solar cell is a photoelectric conversion film.

8. The splicing-type liquid crystal display device as claimed in claim 3, wherein the solar cell is a photoelectric conversion film.

9. The splicing-type liquid crystal display device as claimed in claim 4, wherein the solar cell is a photoelectric conversion film.

10. The splicing-type liquid crystal display device as claimed in claim 5, wherein the solar cell is a photoelectric conversion film.

11. The splicing-type liquid crystal display device as claimed in claim 1, wherein each of the plurality of liquid crystal display screens comprises a protective border, and the protective borders of the plurality of liquid crystal display screens form the splicing gap.

12. The splicing-type liquid crystal display device as claimed in claim 2, wherein each of the plurality of liquid crystal display screens comprises a protective border, and the protective borders of the plurality of liquid crystal display screens form the splicing gap.

13. The splicing-type liquid crystal display device as claimed in claim 3, wherein each of the plurality of liquid crystal display screens comprises a protective border, and the protective borders of the plurality of liquid crystal display screens form the splicing gap.

14. The splicing-type liquid crystal display device as claimed in claim 4, wherein each of the plurality of liquid crystal display screens comprises a protective border, and the protective borders of the plurality of liquid crystal display screens form the splicing gap.

15. The splicing-type liquid crystal display device as claimed in claim 5, wherein each of the plurality of liquid crystal display screens comprises a protective border, and the protective borders of the plurality of liquid crystal display screens form the splicing gap.

16. The splicing-type liquid crystal display device as claimed in claim 1, wherein the plurality of liquid crystal display screens each are a thin film transistor liquid crystal display screen.

17. The splicing-type liquid crystal display device as claimed in claim 2, wherein the plurality of liquid crystal display screens each are a thin film transistor liquid crystal display screen.

18. The splicing-type liquid crystal display device as claimed in claim 3, wherein the plurality of liquid crystal display screens each are a thin film transistor liquid crystal display screen.

19. The splicing-type liquid crystal display device as claimed in claim 4, wherein the plurality of liquid crystal display screens each are a thin film transistor liquid crystal display screen.

20. The splicing-type liquid crystal display device as claimed in claim 5, wherein the plurality of liquid crystal display screens each are a thin film transistor liquid crystal display screen.
